(19) United States
(12) Patent Application Publication
(10) Pub. No.: US 2003/0005323 A1
(43) Pub. Date: Jan. 2, 2003

(54) Management of sensitive data

(76) Inventors: David C. Hanley, Granite Bay, CA (US); Dominique Gougeon, Rocklin, CA (US); Frederic Charlier, Rocklin, CA (US)

Correspondence Address: HEWLETT-PACKARD COMPNAY, Intellectual Property Administration, P. O. Box 272400, Fort Collins, CO, 80527-2400, US

(21) Appl. No.: 09/895,934

(22) Filed: Jun. 29, 2001

(51) Int. Cl. H04L 9/32

(52) U.S. Cl. 713/194

(57) ABSTRACT

Method and apparatus for managing sensitive data. In one embodiment, sensitive data are managed in a circuit arrangement that includes a processor, a RAM, a register, a security circuit, and a power supply. The power supply is arranged to provide power from a first power source when power is available from the first source and from a second power source when power is unavailable from the first source. The processor initially stores the sensitive data in the RAM while operating with power from the first source. Upon loss of power from the first source, the power supply provides power from the second source, and the processor copies the sensitive data from the slow discharging RAM to the register and erases the sensitive data from the RAM. If the second power source is removed, the processor clears the sensitive data from the register. When the security circuit detects an attack on the circuit arrangement, the processor erases the sensitive data from the RAM and from the register.

### FIELD OF THE INVENTION

The present invention relates generally to storage of sensitive data in electronic circuitry, and more specifically, to protecting sensitive data from undesired access.

### BACKGROUND

Point of sale (POS) terminals allow customers to make payments using a variety of payment instruments such as credit cards, debit cards, smart cards, ATM cards, etc. To ensure that the payment information transmitted from the POS terminals to a payment center is not intercepted, this information is typically encrypted and secured through other means (e.g., digital authentication) during transmissions.

However, confidential payment information entered by the user into the POS terminal could still be intercepted by tampering with the POS terminal. To curb such interception and any tampering of the keypad and processor, processors and other circuitry in the POS terminal are sometimes embedded in material such as epoxy resin which is potted to the keypad, thereby integrating the keypad and the circuits into a single module.

While these security measures are sufficient to deter some tampering, the measures could still be circumvented (e.g. by opening the POS terminals and using appropriate chemical substances to remove the potting material. In addition, epoxy potting is expensive and prevents both authorized and unauthorized access to the circuitry within the POS terminal.

Another approach to security is storage of the secret data in an SRAM where the SRAM is erased upon removal or attack. A problem associated with SRAM storage is that the memory is not immediately erased upon removal of power because the memory is erased by discharge of the memory cells, which may take several hours due to internal resistance in the chip. As a result, there is a need for a less expensive, more secure technique for preventing unauthorized access to sensitive data in POS terminals in particular and generally in other electronic circuitry.

A system and method that address the aforementioned problems, as well as other related problems, are therefore desirable.

### SUMMARY OF THE INVENTION

In various embodiments, the invention provides a method and apparatus for managing sensitive data. In one embodiment, sensitive data are managed in a circuit arrangement that includes a processor, a RAM, a register, a security circuit, and a power supply. The power supply is arranged to provide power from a first power source when power is available from the first source and from a second power source when power is unavailable from the first source. The processor initially stores the sensitive data in the RAM while operating with power from the first source. Upon loss of power from the first source, the power supply provides power from the second source, and the processor copies the sensitive data from the slow discharging RAM to the register and erases the sensitive data from the RAM. If the second power source is removed, the circuitry within the processor clears the sensitive data from the register. When the security circuit detects an attack on the circuit arrangement, the processor erases the sensitive data from the RAM and from the register.

Various example embodiments are set forth in the Detailed Description and claims which follow.

### BRIEF DESCRIPTION OF THE DRAWINGS

Various aspects and advantages of the invention will become apparent upon review of the following detailed description and upon reference to the drawings in which:

FIG. 1 is a functional block diagram of a point-of-sale (POS) terminal in accordance with one embodiment of the invention; and

FIG. 2 is a state diagram that illustrates operation of terminal in securing sensitive data in response to different power modes and security threats.

### DETAILED DESCRIPTION

Various embodiments of the present invention are described in terms of a point-of-sale (POS) terminal. Those skilled in the art will appreciate that the invention could be implemented in any application where sensitive data are stored in a RAM and needs to be quickly erased in the event of an attack on the circuitry. In various embodiments of the invention, the sensitive data is protected when the main power is removed from the circuitry and also protected when the circuitry is attacked during normal operations. When operating with the main power, the processor writes the sensitive data to a RAM. If the main power is removed, the circuit arrangement switches to backup power and the processor moves the sensitive data from the slow discharge RAM to a register and then erases the RAM. If the backup power is then removed, the sensitive data in the register is quickly lost. A security circuit is arranged to detect attacks on the circuit arrangement both when the main power source provides power and the backup power source provides power. If an attack is detected, the processor erases both the RAM and the register.

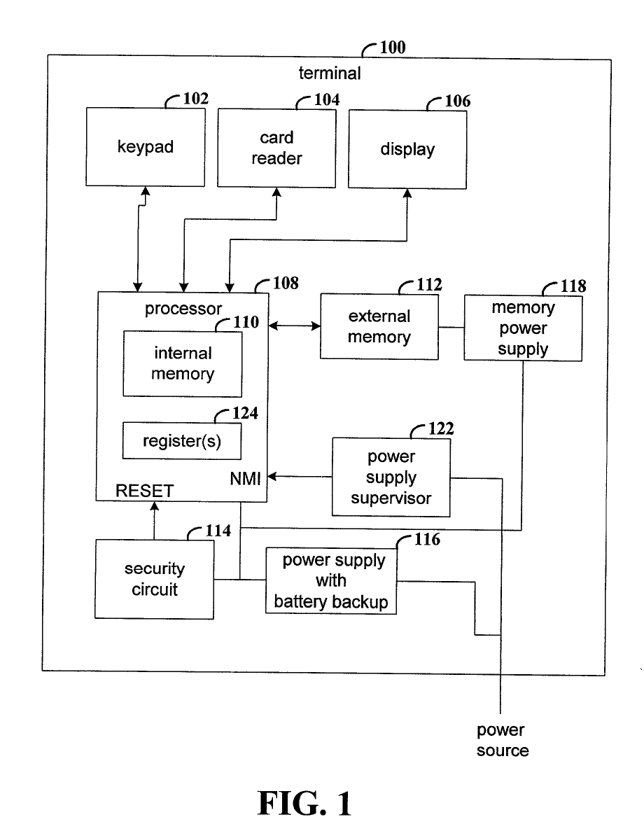

FIG. 1 is a functional block diagram of a point-of-sale (POS) terminal 100 in accordance with one embodiment of the invention. POS terminal 100 includes a keypad 102, a card reader 104 and a display 106. To perform a payment transaction, a user of POS terminal 100 slides a card through card reader 104. The transaction details are then displayed to the user on display 106. In one embodiment, the user then enters via keypad 102 additional information regarding the transaction, such as a security verification code or a PIN number. The information entered by the user is encrypted and transmitted through a secure communication channel to a bank or other transaction clearinghouse. Once the transaction is approved, the user is notified via display 106.

The payment application executes on processor 108, which is coupled to each of the keypad, card reader and display. In one embodiment, the payment application uses DES encryption for encrypting the user's data. The triple DES methodology uses a general encryption key (GEK) for encrypting and decrypting data. During normal operating conditions (e.g., line power and no tampering), the GEK is stored in internal memory 110 of the processor, and encrypted data are stored in external memory 112. Memory 110 is internal to processor 108 in that the processor circuitry and memory circuitry are integrated in the same chip.

Security circuit 114 detects attacks on terminal 100. For example, the security circuit detects acts of tampering with the housing (not shown) of terminal 100. The various types of attacks detected by security circuit 114 include, for example, power supply tampering and drilling or cutting into the terminal housing. In one embodiment, security circuit 114 is implemented using a Maxim MAX969EEE comparator, which monitors a security grid and power supplies. Upon detecting an attack on terminal 100, the security circuit activates a RESET signal to processor 108. If the RESET signal is activated while terminal 100 is supplied with normal line power, the internal that has the GEK is erased. The RESET signal to the CPU (NEC V850E/MS1) is generated by a 74VHC14 Schmidt trigger inverter. Another scenario of tampering with the terminal involves removing line power from the terminal. Line power refers to the main power source of the terminal, for example, a 110 volt AC power source. The objective of the intruder in this scenario is to obtain the GEK from the internal memory 110 before the memory is erased by discharge. The present invention addresses this scenario with additional precautionary steps that are enabled with power supply 116 that includes a battery backup power source. Power supply 116 powers processor 108, security circuit 114, and external memory 112 via memory power supply 118.

Power supply 116 switches from line power to battery power when line power is lost. Power supply supervisor 122 generates a non-maskable interrupt (NMI) pulse to the processor 108 each time there is a change in line power (on to off or off to on). The power supply supervisor also inputs a LINEPWR signal to the processor to indicate whether power is supplied from line power or from battery backup. Upon detecting a loss of line power, the processor copies the GEK from internal memory 110 to one or more registers 124 that are internal to the processor and then erases the internal memory 110. If the battery backup power is removed, the GEK will be quickly discharged from the registers. If the security circuit 114 detects tampering with the terminal, the RESET signal is applied to the processor, and the processor erases the GEK from the registers 124, and the security circuit erases the external memory by momentarily reversing the power supply to the external memory 112. Storing the GEK in one or more registers allows the processor to erase the register(s) when the RESET signal is applied. Thus, there is no reliance on the processor being powered and able to run to erase the internal memory, or reliance on the memory being erased by removing the power supply. The GEK is not permanently stored in the internal register(s) since the register(s) is used for other purposes while the processor is running, for example, I/O port configuration and internal timers.

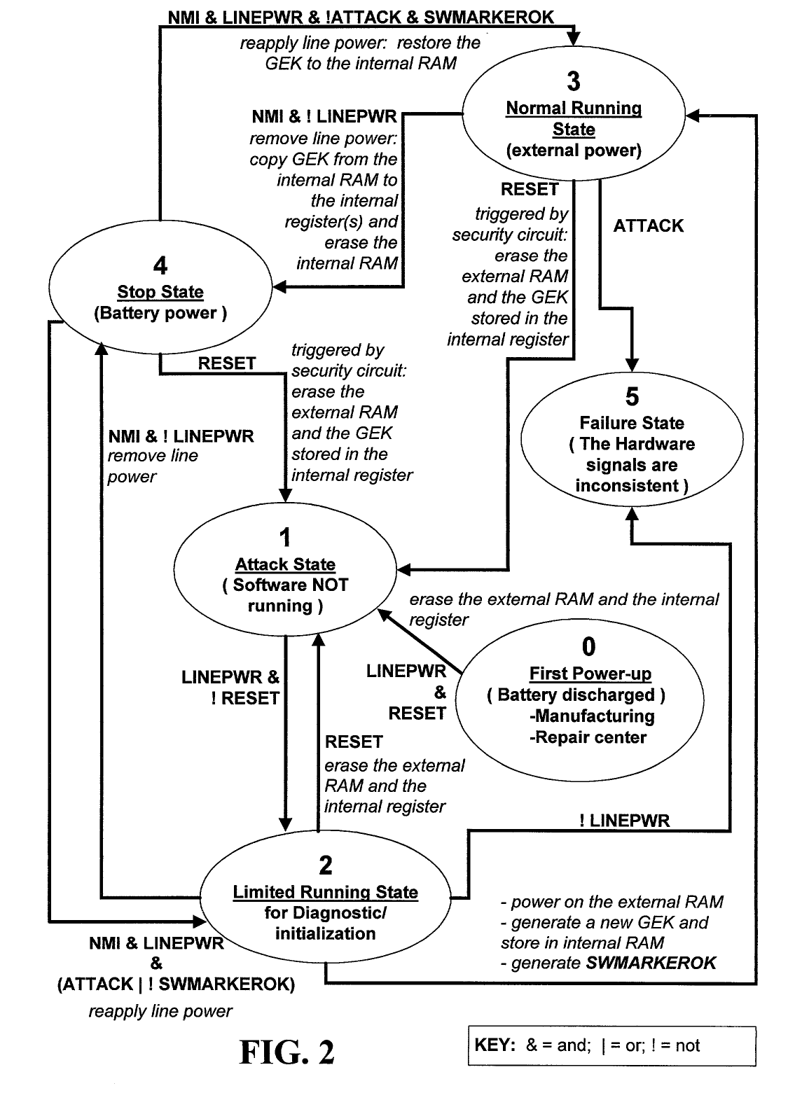

The various components of terminal 100 can be implemented using commercially available parts or proprietary parts, depending on implementation requirements. For example, in one embodiment, processor 108 is an NEC V850/MS1 processor, battery backup power supply includes AAA rechargeable batteries, power supply supervisor is a Micrel MIC841 low power comparator, and external memory 112 is a Cypress CY62126BV 128 KByte by 16 bit low power Static RAM. The power to external memory 112 is provided by either the battery backup or from a switching power supply based on a step down switching regulator (e.g., Linear Technologies LT1576). Power steering between the two supplies is done by Schottky diodes (e.g., Toshiba CRS03).FIG. 2 is a state diagram that illustrates operation of terminal 100 in securing sensitive data in response to different power modes and security threats. State 0 is the initial state from which power is initially applied. For example, when the terminal is assembled and power is first applied, the terminal moves from First Power-up state 0 to Attack state 1. When power is first applied, security circuit 114 activates the RESET signal and power supply supervisor 122 pulses the NMI signal.

State 1 is the Attack state. The processor erases the external memory 112 along with the internal register(s) 124. It can be seen that the Attack state can also be entered from other states in the diagram. The Attack state 1 exits to Limited Running State 2 by application of or continued application of line power. Note that Attack state 1 can be entered via Stop state 4 where line power has been removed.

In Limited Running State 2, various diagnostic and initialization processes are performed. The terminal exits State 2 to one of States 1, 3, 4, or 5, depending on the current operating conditions. If the security circuit 114 reactivate the RESET signal in response to an attack, the terminal returns to Attack State 1 where the external memory and internal register(s) 124 are cleared. If the LINEPWR signal is inactive, the terminal transitions to Failure State 5. If the LINEPWR signal is inactive and the NMI is pulsed, the terminal transitions to Stop State 4 to operate under battery power. During initialization, power is applied to the external memory via memory power supply 118, a new GEK is generated and stored in the internal memory 110, and a new SWMARKER is generated. In one embodiment, the GEK is a randomly generated triple DES key that is used to encrypt the keys in the external memory and to generate the SWMARKER.

The SWMARKER is a software marker value that is used to detect the corruption in the external memory 112. The value of the SWMARKER is generated from a random value that is encrypted (triple DES) using the GEK. The random value is stored in the internal memory 110, and the SWMARKER value is stored in the external memory 112. At each power-up event the processor checks whether the SWMAR ER value in the external memory is correct (relative to encrypting the random value with the GEK). If the SWMARKER value is incorrect, either the GEK, the random value, or the SWMARKER value is corrupt, and signals that an attack has occurred. The SWMARKEROK is the flag in the state diagram that indicates whether the SWMARKER value is correct. Firmware is loaded into the external memory 112 once power is applied, and the terminal then transitions to Normal Running State 3.

As long as line power is normal and there are no attacks detected by the security circuit 114, the terminal remains in the Normal Running State 3. If the security circuit detects an attack while in State 3, the external memory 112 is erased along with the internal register(s) 124 and the terminal transitions to Attack State 1. The ATTACK signal is activated in response to the active RESET signal. The ATTACK signal is cleared when the firmware is reloaded in the external memory in the Limited Running State 2. If the ATTACK signal is active without an active RESET, the terminal transitions to Failure State 5. Upon loss of line power (NMI & !LINEPWR), the terminal transitions to Stop State 4 to operate under battery power. Upon transition to State 4, the GEK is copied from the internal memory 110 to the internal register(s) 124, and the internal memory is erased.

Stop State 4 is an idle state where the processor 108 is placed into a low power mode, and the processor and internal memory are powered by the battery backup of power supply 116. If the security circuit 114 detects an attack and activates the RESET signal, the terminal 100 transitions to Attack state 1, and the external memory is erased and internal register(s) 124 are cleared. If line power is reapplied and either the ATTACK signal is active or the external memory is corrupt (NMI & LINEPWR & (ATTACK|!SWMARKEROK)), then the terminal transitions back to Limited Running State 2. If line power is reapplied and the ATTACK signal is inactive and the external memory 112 is not corrupt (NMI & LINEPWR & !ATTACK & SWMARKEROK), the terminal transitions back to Normal Running State 3.

The present invention is believed to be applicable to a variety of electronic systems and has been found to be particularly applicable and beneficial in POS terminals. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for managing sensitive data in a point-of-sale terminal having a first memory element, a processor having a register, a security circuit, and a power supply circuit arranged to provide power from a first power source when power is available from the first source and from a second power source when power is unavailable from the first source, comprising:
storing sensitive data in the first memory element;
upon loss of power from the first source, switching to power from the second source, copying the sensitive data from the first memory element to the register, and erasing the sensitive data from the first memory element; and
upon detecting an attack on the terminal, erasing the sensitive data from the first memory element and from the register.

2. The method of claim 1, further comprising upon reapplication of power from the first source, copying the sensitive data from the register to the RAM.

3. The method of claim 2, wherein the sensitive data includes a general encryption key.

4. The method of claim 3, wherein the first memory element is RAM internal to the processor, and the terminal further includes a second memory element that is a RAM external to the processor, the method further comprising:
generating encrypted data using the general encryption key; and
storing the encrypted data in the second memory element.

5. The method of claim 4, further comprising:
generating a random value;
storing the random value in the first memory element;
encrypting the random value as a marker value using the general encryption key;
storing the marker value in the second memory element; and
upon application of power from the first source, generating a temporary marker value from the random value stored in the first memory element and the general encryption key, wherein an attack is detected if the temporary marker value is not equal to the marker value in the second memory element.

6. The method of claim 1, wherein the sensitive data includes a general encryption key.

7. The method of claim 6, wherein the first memory element is RAM internal to the processor, and the terminal further includes a second memory element that is a RAM external to the processor, the method further comprising:
generating encrypted data using the general encryption key; and
storing the encrypted data in the second memory element.

8. The method of claim 7, further comprising:
generating a random value;
storing the random value in the first memory element;
encrypting the random value as a marker value using the general encryption key;
storing the marker value in the second memory element; and
upon application of power from the first source, generating a temporary marker value from the random value stored in the first memory element and the general encryption key, wherein an attack is detected if the temporary marker value is not equal to the marker value in the second memory element.

9. An apparatus for managing sensitive data in a point-of-sale terminal having a first memory element, a processor having a register, a security circuit, and a power supply circuit arranged to provide power from a first power source when power is available from the first source and from a second power source when power is unavailable from the first source, comprising:
means for storing sensitive data in the first memory element;
means, responsive to a loss of power from the first source, for switching to power from the second source, copying the sensitive data from the first memory element to the register, and erasing the sensitive data from the first memory element; and
means for detecting an attack on the terminal; and
means for erasing the sensitive data from the first memory element and from the register in response to an attack on the terminal.

10. A circuit arrangement providing for erasure of sensitive data, comprising:
a first memory element;
a register;
a security circuit configured to detect a security threat to the circuit arrangement and generate a first signal upon detection of a security threat;
a power supply coupled to the first memory element, the register, and the security circuit, the power supply arranged to provide power from a first power source when power is available from the first source and from a second power source when power is unavailable from the first source; and
a processor coupled to the RAM, the register, the security circuit and the power supply, the processor configured to store sensitive data in the RAM when power is available from the first source, and upon application of power from the second power source copy the sensitive data from the RAM to the register and erase the sensitive data from the RAM.

11 The circuit arrangement of claim 10, wherein the processor is further configured to copy the sensitive data from the register to the RAM upon reapplication of power from the first source.

12. The circuit arrangement of claim 11, wherein the sensitive data includes a general encryption key.

13. The circuit arrangement of claim 12, wherein the first memory element is RAM internal to the processor, and further comprising:
a second memory element that is a RAM external and coupled to the processor; and
wherein the processor is further configured to generate encrypted data using the general encryption key and store the encrypted data in the second memory element.

14. The circuit arrangement of claim 13, wherein the processor is further configured to generate a random value and store the random value in the first memory element, encrypt the random value as a marker value using the general encryption key and store the marker value in the second memory element, and upon application of power from the first source, generate a temporary marker value from the random value stored in the first memory element and the general encryption key, detect an attack if the temporary marker value is not equal to the marker value in the second memory element.
